(19) United States
(12) Patent Application Publication
(10) Pub. No.: US 2026/0160312 A1
(43) Pub. Date: Jun. 11, 2026

(54) MAGNETORHEOLOGICAL DAMPER CAPABLE OF REALIZING INDEPENDENT LINEAR AND ROTATIONAL FORCE FEEDBACK

(71) Applicant: SOUTHEAST UNIVERSITY, Jiangsu (CN)

(72) Inventors: Huijun LI, Jiangsu (CN); Zhongyu SUN, Jiangsu (CN); Ye LU, Jiangsu (CN); Maozeng ZHANG, Jiangsu (CN); Ye LI, Jiangsu (CN); Aiguo SONG, Jiangsu (CN); Baoguo XU, Jiangsu (CN)

(73) Assignee: SOUTHEAST UNIVERSITY, Jiangsu (CN)

(21) Appl. No.: 19/388,889

(22) Filed: Nov. 13, 2025

Related U.S. Application Data
(63) Continuation of application No. PCT/CN2025/084006, filed on Mar. 21, 2025.

(30) Foreign Application Priority Data
Dec. 11, 2024 (CN) 202411820072.0

(51) Int. Cl. F16F 9/53; F16F 9/32

(52) U.S. Cl. CPC F16F 9/535; F16F 9/3221; F16F 2224/02; F16F 2230/0005; F16F 2230/30

(57) ABSTRACT

A magnetorheological damper capable of providing independent linear and rotational force feedback includes two cylinders filled with magnetorheological fluid. The first cylinder is internally provided with a piston head assembly and a piston rod axially penetrating the cylinder, and the piston head assembly is provided with a coil wound with an enameled wire, and is connected to a piston rod through two rotary bearings. The piston rod is configured to drive the piston head assembly to move in a linear direction, and different damping forces can be generated in the linear direction by changing a current in the enameled wire. The second cylinder is internally provided with a stationary drum and a rotary drum that is rotatably fixed to the piston rod, which is configured to drive the rotary drum to rotate in the second cylinder, thereby squeezing the magnetorheological fluid to generate different damping forces in the rotational direction.

### CROSS-REFERENCE TO RELATED APPLICATION

This application is a continuation of International Application of PCT application serial no. PCT/CN2025/084006 filed on Mar. 21, 2025, which claims the priority benefit of China application serial no. 202411820072.0 filed on Dec. 11, 2024. The entirety of each of the above-mentioned patent applications is hereby incorporated by reference herein and made a part of this specification.

### BACKGROUND

### Technical Field

The present disclosure relates to the technical field of magnetorheological damping regulation, and in particular to a magnetorheological damper capable of realizing independent linear and rotational force feedback.

### Description of Related Art

Magnetorheological (MR) fluid is a novel intelligent material with controllable flow characteristics. It is composed of nanoscale magnetic particles, a carrier fluid, and various additives. The rheological properties of MR fluid are dependent on an external magnetic field. When the external magnetic field is applied, its rheological properties transform from low-viscosity Newtonian fluid to high-viscosity and low-flow Bingham fluid. This transformation is easy to control and has a rapid response. An MR damper is a passive feedback device that uses MR fluid as an operating medium to provide operational damping. The output damping force can be controlled by adjusting the coil current.

The MR fluid can be classified into three operating modes: flow mode, shear mode, and squeeze mode. Based on the above operating modes, MR dampers are categorized into rotary MR damper and valve-type MR damper. The rotary MR damper provides damping torque in a rotational direction by squeezing the MR fluid between relatively rotating components and stationary components, whereas the valve-type MR damper provides damping force in a linear direction by moving a piston linearly within a piston chamber to squeeze the MR fluid. However, existing MR dampers, regardless of their operating mode, can only provide force feedback for a single degree of freedom, failing to meet the demands of applications requiring force feedback in both rotational and linear directions.

Therefore, to meet the application scenarios that require rotational and linear force feedback for multiple degrees of freedom, the present disclosure combines the operating modes of valve-type and rotary MR dampers, and provides an MR damper capable of realizing independent linear and rotational force feedback. The damper enables force feedback for two degrees of freedom, that is, rotational and linear motion, eliminating coupling of the force feedback for two degrees of freedom.

### SUMMARY

To address the above-mentioned technical problems, the present disclosure provides a magnetorheological damper capable of realizing independent linear and rotational force feedback, so as to overcome the problem that the existing dampers can only provide force feedback in a single degree of freedom, thus meeting the demands of more diversified force feedback.

In order to achieve the above objectives, the present disclosure implements the following technical solution:
a magnetorheological damper capable of realizing independent linear and rotational force feedback includes a first cylinder body, a second cylinder body, a first magnetically conductive sleeve, a second magnetically conductive sleeve, and a magnetic-resistance sleeve. The first cylinder body is internally provided with a first piston rod, a second piston rod, and a piston assembly. The piston assembly is composed of a second bearing, an iron core, a first coil, and a second bearing. An enameled wire of the first coil is led out through a wire guide hole in a lower end cap. An end of the first piston rod is provided with a threaded hole, and an end of the second piston rod is provided with a threaded portion. The first piston rod and the second piston rod extend through the piston assembly and are fastened inside the piston assembly, such that the piston assembly moves with the piston rods in a linear direction and remains stationary in a rotational direction. The second piston rod passes through a ball bushing, providing linear guidance for the piston rod, and the ball bushing is fixedly connected to the lower end cap;
the second cylinder body includes a rotary drum and a stationary drum; the rotary drum is composed of a rotary drum body and a rotary drum bracket, and the rotary drum body and the rotary drum bracket are fixed. An end of the rotary drum bracket is fixed to a first bearing via a first retaining spring and a second retaining spring, and the first bearing is fixed on an inner side of the upper end cap, thereby enabling the rotary drum bracket to drive the rotary drum body to perform rotational motion; a rectangular protrusion formed on the first piston rod fits into a groove on the rotary drum bracket, such that the rotary drum moves with the piston rod in the rotational direction while remaining stationary in the linear direction; the stationary drum includes a stationary drum body and a stationary drum bracket, and the stationary drum body and the stationary drum bracket are fixed; the stationary drum bracket is connected to a second coil, the second coil is connected to a magnetically conductive member; and an enameled wire of the second coil is led out through a wire guide hole formed in a housing;
the first cylinder body is filled with a magnetorheological (MR) fluid. In the first cylinder body, a magnetic flux path is formed among the iron core of the piston head assembly, the first magnetically conductive sleeve, and the MR fluid in the cylinder. The second cylinder body is filled with a MR fluid. In the second cylinder body, a magnetic flux path is formed among the rotary drum body, the stationary drum body, the second magnetically conductive sleeve, and the magnetically conductive member;
a magnetic-resistance sleeve is disposed inside the second magnetically conductive sleeve, and the first magnetically conductive sleeve is disposed inside the magnetic-resistance sleeve; and the second magnetically conductive sleeve is fixed to the lower end cap by M2 screws, and the upper end cap and the lower end cap are fixed to the housing by M3 screws; and

The first cylinder body is filled with a MR fluid, an outer wall of the first cylinder body is provided with the first magnetically conductive sleeve, and a magnetic flux path is formed between the iron core of the piston head assembly and the MR fluid in the cylinder. Further, a gap between the piston head assembly and the magnetically conductive sleeve forms a damping channel for the flow of MR fluid. By varying a current in the first coil, a damping force in the linear direction can be adjusted.

Further, the second cylinder body is filled with a MR fluid, and a second magnetically conductive sleeve is disposed on an inner side of the annular cavity. A second coil wound with enameled wire is disposed below the stationary drum bracket, and a magnetically conductive member made of pure electrical iron is disposed at a bottom of the second coil. A magnetic flux path is formed among the second magnetically conductive sleeve, the stationary drum body, the rotary drum body, the second magnetically conductive sleeve, and the magnetically conductive member. Further, a damping channel for the flow of MR fluid is formed between two stationary drum bodies and three rotary drum bodies in the second cylinder body. By varying a current in the second coil, a damping force in the rotational direction can be adjusted.

Further, the first magnetically conductive sleeve, the second magnetically conductive sleeve, and the magnetic-resistance sleeve are fixed using a fastening bolt to prevent relative sliding.

Further, both the first magnetically conductive sleeve and the second magnetically conductive sleeves are made of a magnetically conductive material, that is, pure electrical iron; each of the first magnetically conductive sleeve and the second magnetically conductive is provided with a magnetic-resistance sleeve made of aluminum. The magnetic-resistance sleeve is capable of blocking magnetic flux lines from passing through, thereby preventing magnetic coupling between the magnetic fields generated by the first coil and the second coil.

Further, a ferromagnetic seal is disposed between the rotary drum bracket and the upper end cap to prevent leakage of magnetic particles contained in the MR fluid.

Further, the ferromagnetic seal is composed of an iron ring and a magnetic ring, one surface of the magnetic ring is attached to the rotary drum bracket, and the other surface thereof is attached to the iron ring. A closed magnetic circuit is thus formed among the rotary drum bracket, the iron ring, and the MR fluid in a gap, thereby solidifying the MR fluid.

Further, the first piston rod is in contact with an upper end cap via a first sealing ring, the second piston rod is in contact with the lower end cap via a second sealing ring, and a sealing ring is disposed at a connection among the piston rod, the upper end cap and the lower end cap of the MR damper. An upper end of the rotary drum bracket is fixed to a rotating bearing by a retaining spring, and the bearing is fixed inside the upper end cap. A magnetic ring and an iron ring are arranged at a top of the rotary drum bracket to form a ferromagnetic seal capable of preventing leakage of the MR fluid.

Compared with the prior art, the present disclosure has the following beneficial effects:

The present disclosure combines the operating modes of valve-type and rotary MR dampers, and provides a magnetorheological damper capable of realizing independent linear and rotational force feedback. The damper enables force feedback for two degrees of freedom, that is, rotational and linear motion, eliminating coupling of the force feedback for two degrees of freedom.

### BRIEF DESCRIPTION OF THE DRAWINGS

FIG. 1 is a schematic structural diagram of an MR damper capable of realizing independent linear and rotational force feedback according to the present disclosure.

FIG. 2 is a schematic diagram illustrating connection relationships among various components according to the present disclosure.

FIG. 3 is a schematic diagram illustrating internal magnetic flux paths according to the present disclosure.

FIG. 4 illustrates appearance views of the present disclosure from different perspectives.

FIG. 5 is a quarter-sectional view according to the present disclosure.

FIG. 6 is a diagram illustrating a connection between a piston rod and a piston assembly.

### DESCRIPTION OF THE EMBODIMENTS

The present disclosure will be further described below with reference to the accompanying drawings and the embodiments.

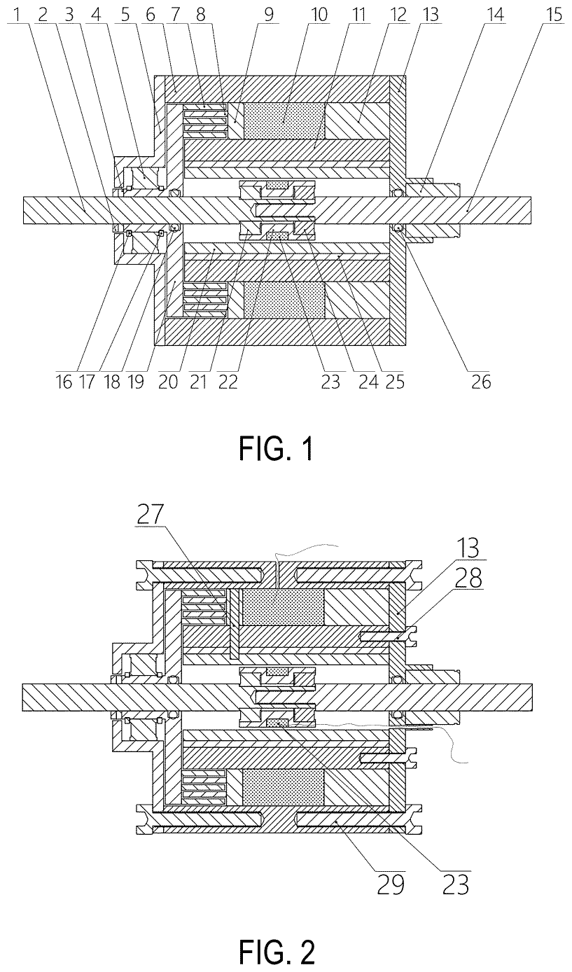

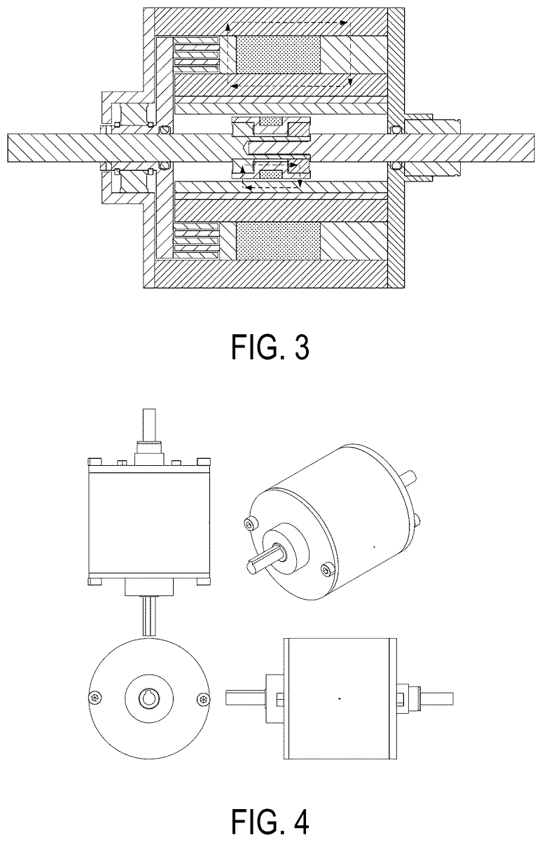

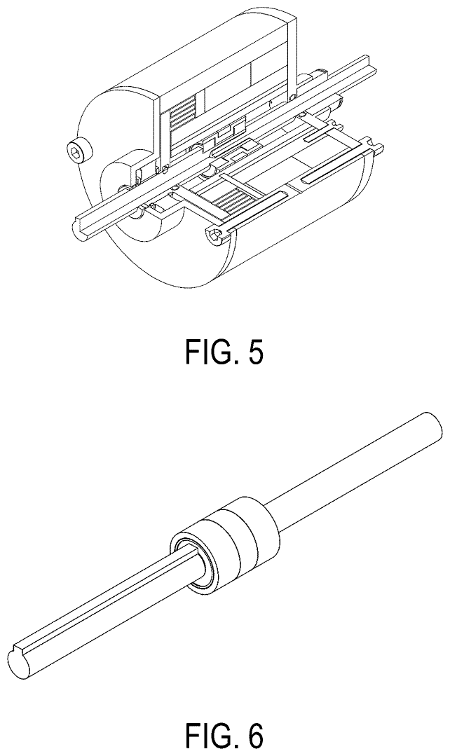

FIG. 1 is a schematic structural diagram of a magnetorheological damper capable of realizing independent linear and rotational force feedback according to the present disclosure. FIG. 2 is a schematic diagram illustrating connection relationships among various components according to the present disclosure. FIG. 3 is a schematic diagram illustrating internal magnetic flux paths according to the present disclosure. FIG. 4 illustrates appearance views of the present disclosure from different perspectives. FIG. 5 is a quarter-sectional view according to the present disclosure. FIG. 6 is a diagram illustrating a connection between a piston rod and a piston assembly. As shown in the figures, a magnetorheological damper capable of realizing independent linear and rotational force feedback in this embodiment includes a first cylinder body and a second cylinder body. The first cylinder body is internally provided with a first piston rod 1, a second piston rod 15, and a piston assembly. The piston assembly is composed of a second bearing 21, an iron core 22, a first coil 23, and a second bearing 24. An enameled wire of the first coil 23 is led out through a wire guide hole in a lower end cap 13, as shown in FIG. 2. An end of the first piston rod 1 is provided with a threaded hole, and an end of the second piston rod 15 is provided with a threaded portion, as shown in FIG. 6. The first piston rod 1 and the second piston rod 15 extend through the piston assembly and are fastened inside the piston assembly, such that the piston assembly moves with the piston rods in a linear direction and remains stationary in a rotational direction. The first piston rod 1 is in contact with an upper end cap 5 via a first sealing ring 18, and the second piston rod 15 is in contact with the lower end cap 13 via a second sealing ring 26. The second piston rod 15 passes through a ball bushing 14, providing linear guidance for the piston rod, and the ball bushing 14 is fixedly connected to the lower end cap 13.

In this embodiment, the second cylinder body includes a rotary drum and a stationary drum. The rotary drum is composed of a rotary drum body 7 and a rotary drum bracket 19, and the rotary drum body 7 and the rotary drum bracket 19 are fixed. An end of the rotary drum bracket 19 is fixed to a first bearing 4 via a first retaining spring 16 and a second retaining spring 17, and the first bearing is fixed on an inner side of the upper end cap 5, thereby enabling the rotary drum bracket 19 to drive the rotary drum body 7 to perform rotational motion. As shown in FIG. 5, a rectangular protrusion formed on the first piston rod fits into a groove on the rotary drum bracket 19, such that the rotary drum moves with the piston rod in the rotational direction while remaining stationary in the linear direction. The stationary drum includes a stationary drum body 8 and a stationary drum bracket 9, and the stationary drum body 8 and the stationary drum bracket 9 are fixed. The stationary drum bracket 9 is connected to a second coil 10, the second coil 10 is connected to a magnetically conductive member 12. An enameled wire of the second coil is led out through a wire guide hole formed in a housing 6, as shown in FIG. 2.

In this embodiment, a first magnetically conductive sleeve 20, a second magnetically conductive sleeve 11, and a magnetic-resistance sleeve 25 are fixed using a fastening bolt 27 to prevent relative sliding. The second magnetically conductive sleeve 11 is fixed to the lower end cap 13 by M2 screws. The upper end cap 5 and the lower end cap 13 are fixed to the housing 6 by M3 screws, as shown in FIG. 2.

In this embodiment, a ferromagnetic seal is disposed between the rotary drum bracket 19 and the upper end cap 5 to prevent leakage of magnetic particles contained in the MR fluid. The ferromagnetic seal is composed of an iron ring 2 and a magnetic ring 3. One surface of the magnetic ring 3 is attached to the rotary drum bracket 19, and the other surface thereof is attached to the iron ring 2. A closed magnetic circuit is thus formed among the rotary drum bracket 19, the iron ring 2, and the MR fluid in a gap, thereby solidifying the MR fluid and preventing the leakage of magnetic particles.

In this embodiment, in the first cylinder body, a magnetic flux path is formed among the iron core 22 of the piston head assembly, the first magnetically conductive sleeve 20, and the MR fluid in the cylinder. In the second cylinder body, a magnetic flux path is formed among the rotary drum body 7, the stationary drum body 8, the second magnetically conductive sleeve 11, and the magnetically conductive member 12. A schematic diagram of the magnetic flux paths is shown in FIG. 3.

The above description is merely a preferred embodiment of the present disclosure and is not intended to limit the present disclosure in any form. Any equivalent modifications or variations made based on the technical essence of the present disclosure shall fall within the scope of protection claimed by the present disclosure.

What is claimed is:

1. A magnetorheological damper capable of realizing independent linear and rotational force feedback, comprising a first cylinder body, a second cylinder body, a first magnetically conductive sleeve, a second magnetically conductive sleeve, and a magnetic-resistance sleeve, wherein the first cylinder body is internally provided with a first piston rod, a second piston rod, and a piston assembly; the piston assembly comprises a second bearing, an iron core, a first coil, and a second bearing, and an enameled wire of the first coil is led out through a wire guide hole in a lower end cap; an end of the first piston rod is provided with a threaded hole, and an end of the second piston rod is provided with a threaded portion; the first piston rod and the second piston rod extend through the piston assembly and are fastened inside the piston assembly, enabling the piston assembly to move with the piston rods in a linear direction and remain stationary in a rotational direction; and the second piston rod passes through a ball bushing to provide linear guidance for the piston rod, and the ball bushing is fixedly connected to the lower end cap;
the second cylinder body comprises a rotary drum and a stationary drum; the rotary drum comprises a rotary drum body and a rotary drum bracket, and the rotary drum body and the rotary drum bracket are fixed; an end of the rotary drum bracket is fixed to a first bearing via a first retaining spring and a second retaining spring, and the first bearing is fixed on an inner side of an upper end cap, thereby enabling the rotary drum bracket to drive the rotary drum body to perform rotational motion; a rectangular protrusion is formed on the first piston rod, and fits into a groove on the rotary drum bracket, enabling the rotary drum to move with the piston rods in the rotational direction and remain stationary in the linear direction; the stationary drum comprises a stationary drum body and a stationary drum bracket, and the stationary drum body and the stationary drum bracket are fixed; the stationary drum bracket is connected to a second coil, the second coil is connected to a magnetically conductive member; and an enameled wire of the second coil is led out through a wire guide hole formed in a housing;
the first cylinder body is filled with a magnetorheological fluid; in the first cylinder body, a magnetic flux path is formed among the iron core of the piston head assembly, the first magnetically conductive sleeve, and the magnetorheological fluid in the cylinder; the second cylinder body is filled with a magnetorheological fluid; and in the second cylinder body, a magnetic flux path is formed among the rotary drum body, the stationary drum body, the second magnetically conductive sleeve, and the magnetically conductive member; and
the magnetic-resistance sleeve is disposed inside the second magnetically conductive sleeve, and the first magnetically conductive sleeve is disposed inside the magnetic-resistance sleeve; and
the second magnetically conductive sleeve is fixed to the lower end cap by M2 screws, and the upper end cap and the lower end cap are fixed to the housing by M3 screws.

2. The magnetorheological damper capable of realizing independent linear and rotational force feedback according to claim 1, wherein the first magnetically conductive sleeve, the second magnetically conductive sleeve, and the magnetic-resistance sleeve are fixed using a fastening bolt.

3. The magnetorheological damper capable of realizing independent linear and rotational force feedback according to claim 2, wherein both the first magnetically conductive sleeve and the second magnetically conductive sleeve are made of a magnetically conductive material, that is, pure electrical iron, and each of the first magnetically conductive sleeve and the second magnetically conductive sleeve is provided with the magnetic-resistance sleeve made of aluminum.

4. The magnetorheological damper capable of realizing independent linear and rotational force feedback according to claim 1, wherein a ferromagnetic seal is disposed between the rotary drum bracket and the upper end cap.

5. The magnetorheological damper capable of realizing independent linear and rotational force feedback according to claim 4, wherein the ferromagnetic seal comprises an iron ring and a magnetic ring, one surface of the magnetic ring is attached to the rotary drum bracket, and the other surface thereof is attached to the iron ring; and a closed magnetic circuit is formed among the rotary drum bracket, the iron ring, and the magnetorheological fluid in a gap, thereby solidifying the magnetorheological fluid.

6. The magnetorheological damper capable of realizing independent linear and rotational force feedback according to claim 1, the first piston rod is in contact with the upper end cap via a first sealing ring, and the second piston rod is in contact with the lower end cap via a second sealing ring.
